(19) United States
(12) Patent Application Publication
(10) Pub. No.: US 2022/0011750 A1
(43) Pub. Date: Jan. 13, 2022

(54) INFORMATION PROJECTION SYSTEM, CONTROLLER, AND INFORMATION PROJECTION METHOD

(71) Applicant: KAWASAKI JUKOGYO KABUSHIKI KAISHA, Kobe-shi, Hyogo (JP)

(72) Inventors: Hitoshi HASUNUMA, Kobe-shi (JP); Shigekazu SHIKODA, Kobe-shi (JP); Takeshi YAMAMOTO, Kobe-shi (JP); Naohiro NAKAMURA, Kobe-shi (JP); Kazuki KURASHIMA, Kobe-shi (JP)

(73) Assignee: KAWASAKI JUKOGYO KABUSHIKI KAISHA, Kobe-shi, Hyogo (JP)

(21) Appl. No.: 17/312,178

(22) PCT Filed: Dec. 18, 2019
(86) PCT No.: PCT/JP2019/049505

§ 371 Date: Jun. 9, 2021

(30) Foreign Application Priority Data
Dec. 18, 2018 (JP) 2018-236080

(51) Int. Cl. G05B 19/418; G05B 19/4063

(52) U.S. Cl. CPC G05B 19/4183; G05B 2219/37074; G05B 19/4187; G05B 19/4063

(57) ABSTRACT

The information projection system includes stereo cameras, a controller, and projectors. The controller has a communication device, an analysis unit, a registration unit, and a projection control unit. The communication device acquires sets of appearance information in which each stereo camera detects an appearance of a workplace. The analysis unit analyzes the sets of appearance information, and creates a map information indicating shapes and positions of objects existing in the workplace. The registration unit creates and registers a work status information based on the map information that is individually created from the sets of appearance information respectively detected by the plurality of stereo cameras. The projection control unit creates an auxiliary image for assisting a work based on the work status information, and outputs the auxiliary image to each projector.

### TECHNICAL FIELD

The present invention mainly relates to an information projection system for projecting information to a workplace.

### BACKGROUND ART

A system for supporting works, in a workplace where works such as processing, painting, and assembling of components are performed, by using virtual images has been conventionally known. PTL 1 discloses this kind of system using a head mount display (hereinafter, referred to as an HMD).

PTL 1 discloses, as an example, a system for supporting an assembling work in which a cylindrical component is mounted to a body component. The HMD that is put by a worker on his/her head has an imaging portion. The imaging portion detects a marker in the workplace, which can estimate a position and a posture of the imaging portion. Three-dimensional data of the cylindrical component has acquired in advance. A display in the HMD displays a virtual image of the cylindrical component created based on the three-dimensional data, near the actual body component that is visible for the worker. The display in the HMD further displays moving locus for assembling the cylindrical component. This allows the worker to intuitively understand an assembling procedure.

### CITATION LIST

### Patent Literature

PTL 1: Japanese Patent Application Laid-Open No. 2014-229057

### SUMMARY OF THE INVENTION

### Problems to be Solved by the Invention

However, in the system in PTL 1, a plurality of workers cannot share the common image because the images are displayed on the HMD. It is possible that, of course, each worker puts the HMD to display the common image. This leads to, however, additional works to confirm whether the common image is displayed, and to communicate the image on which the one of the workers focuses, to other workers. It is required to communicate further information to the workers in order to increase work efficiency.

The present invention has been made in view of the circumstances described above, an object of the present invention is to provide, in a system for supporting works by using images regarding works, a configuration in which the images regarding the works can be easily shared among a plurality of workers, the configuration in which the workers can recognize the images based on detected information.

### Means for Solving the Problems Thereof

Problems to be solved by the present invention are as described above, and next, means for solving the problems and effects thereof will be described.

According to a first aspect of the present invention, provided is an information projection system including a plurality of appearance sensors for detecting an appearance of a workplace, a controller, and a projector for projecting images. The controller has an acquisition unit, an analysis unit, a registration unit, and a projection control unit. The acquisition unit acquires sets of appearance information obtained by detecting the appearance of the workplace by using the plurality of appearance sensors. The analysis unit analyzes the sets of appearance information acquired by the acquisition unit, and creates a map information indicating shapes and positions of objects existing in the workplace. The registration unit creates and registers a work status information regarding a work status in the workplace, based on the map information that is individually created from the sets of appearance information respectively detected by the plurality of the appearance sensors, or based on the map information created by integrating the sets of appearance information. The projection control unit creates an auxiliary image for assisting workers' work in the workplace based on the work status information, outputs the auxiliary image to the projector, and then projects the auxiliary image to the workplace.

According to a second aspect of the present invention, provided is a controller which acquires sets of appearance information detected by a plurality of appearance sensors for detecting an appearance in a workplace, the controller which outputs an image to be projected by a projector to the projector. The controller includes an analysis unit, a registration unit, and a projection control unit. The analysis unit analyzes the sets of appearance information and creates a map information indicating shapes and positions of objects existing in the workplace. The registration unit creates and registers a work status information regarding a work status in the workplace, based on the map information that is individually created from the sets of appearance information respectively detected by the plurality of the appearance sensors, or based on the map information created by integrating the sets of appearance information. The projection control unit creates, based on the work status information, an auxiliary image for assisting workers' work in the workplace, outputs the auxiliary image to the projector, and then projects the auxiliary image to the workplace.

According to a third aspect of the present invention, an information projection method is provided as follows. That is, the information projection method includes an acquisition step, an analysis step, a registration step, and a projection control step. The acquisition step is to acquire sets of appearance information obtained by detecting an appearance of a workplace by using a plurality of appearance sensors. The analysis step is to analyze the sets of appearance information acquired in the acquisition step, and then create a map information indicating shapes and positions of objects existing in the workplace. The registration step is to create and register a work status information regarding a work status in the workplace, based on the map information that is individually created from the sets of appearance information respectively detected by the plurality of appearance sensors, or based on the map information created by integrating the sets of appearance information. The projection control step is to create an auxiliary image for assisting workers' work in the workplace based on the work status information, output the auxiliary image to a projector, and then project the auxiliary image to the workplace.

Accordingly, unlike a configuration in which the auxiliary image is displayed on the HMD, projected images can be easily shared among the plurality of workers. The auxiliary image based on the work status information that is not predetermined information, but detected information, is projected to the workplace. Therefore, the workers can recognize various information regarding objects existing in the workplace.

### Effects of Invention

According to the present invention, its main object is to achieve, in a system for supporting works by using images regarding works, a configuration in which images regarding the works can be easily shared among a plurality of workers, the configuration in which the workers can recognize the images based on detected information.

### BRIEF DESCRIPTION OF THE DRAWINGS

FIG. 1 A schematic view showing a configuration of an information projection system according to one embodiment of the present invention.

FIG. 2 A diagram showing a situation in which an auxiliary image indicating names of objects and work details is projected to a workplace.

FIG. 3 Tables showing work statuses for each worker and for each work process obtained based on a work status information.

FIG. 4 A diagram showing a situation in which an auxiliary image based on information obtained by one of the workers is projected to the workplace.

FIG. 5 A diagram showing a variation in which a stereo camera and a projector are arranged in the workplace instead of a worker terminal.

### EMBODIMENT FOR CARRYING OUT THE INVENTION

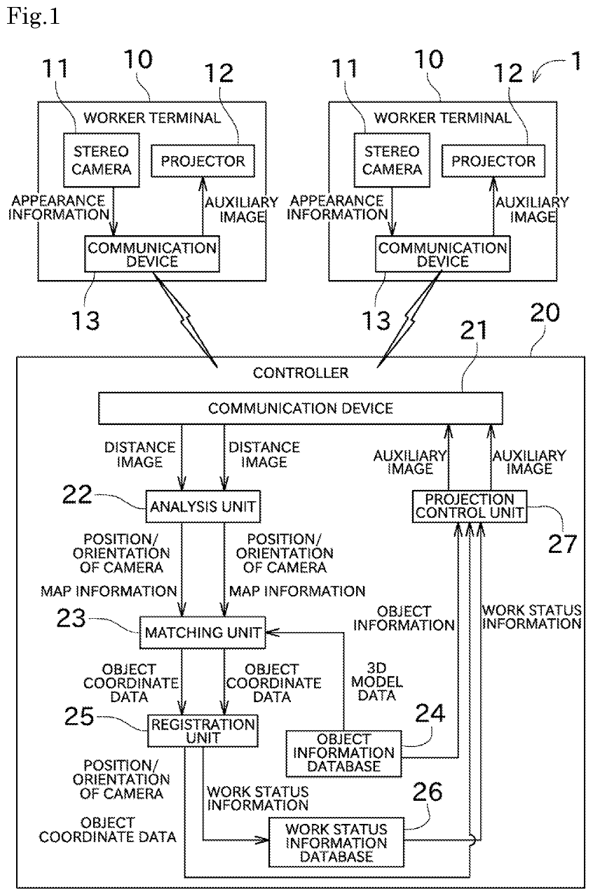

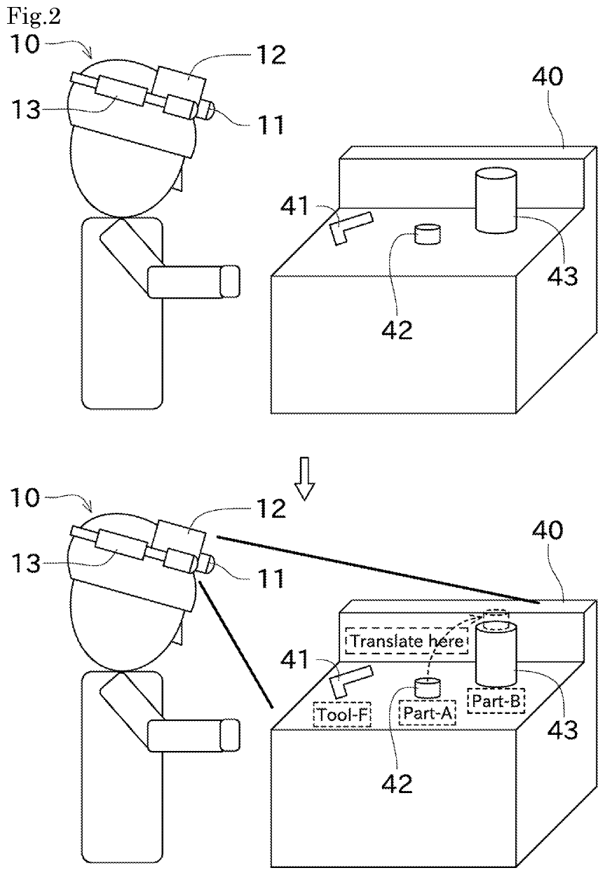

Next, an embodiment of the present invention will be described with reference to drawings. FIG. 1 is a schematic view showing a configuration of an information projection system according to one embodiment of the present invention. FIG. 2 is a diagram showing a situation in which an auxiliary image indicating names of objects and work details is projected to a workplace.

An information projection system 1 of this embodiment is configured to acquire a work status in real time in a workplace where components are processed, painted, and assembled. The information projection system 1 is configured to project an auxiliary image for assisting workers' work, to the workplace. The information projection system 1 includes a plurality of worker terminals 10 and a controller 20 which manages and controls the plurality of worker terminals 10.

Each of the worker terminals 10 is a device worn by a plurality of workers one by one. As shown in FIG. 2, each worker puts the corresponding worker terminal 10 of this embodiment on his/her head. Each worker terminal 10 may be integrated with a work helmet or may be removable from the work helmet. Each worker terminal 10 may be put on any position other than his/her head. In this embodiment, the plurality of workers works in the workplace. Each worker puts the corresponding worker terminal 10. Therefore, the information projection system 1 includes the plurality of worker terminals 10. “The plurality of worker terminals 10” means that there are multiple (two or more) terminals respectively worn by the separate worker (in other words, the terminals which are apart from each other, the terminals in which its position can be independently changed). Each worker terminal 10 may have exactly the same configuration or may have a different configuration. The plurality of worker terminal 10 has a plurality of stereo cameras (appearance sensors) 11, projectors 12, and communication devices 13, which correspond one-to-one to each worker terminal 10. Therefore, the information projection system 1 includes the plurality of stereo cameras 11 (appearance sensors). Each of the appearance sensors is a sensor for acquiring an appearance of the workplace. “The plurality of appearance sensors” means that there are multiple (two or more) sensors which are apart from each other, the sensors for independently detecting available data.

Each of the stereo cameras 11 includes a pair of image sensors that is placed at an appropriate distance separated from each other. Each image sensor is, for example, CCD (Charge Coupled Device). The two image sensors work in synchronization with each other, and create a pair of image data by shooting the workplace at the same time. In this embodiment, since it is assumed that information detected in real time is projected as the auxiliary image, each stereo camera 11 preferably takes multiple shots per second, for example.

Each stereo camera 11 includes an image processing unit which processes the pair of image data. The image processing unit performs a known stereo matching process for the pair of image data obtained by each stereo camera 11. This can calculate displacement (parallax) of a position corresponding to each image. As the distance is closer to objects, the parallax is larger in inverse proportion to the distance. Based on such parallax, the image processing unit creates a distance image in which distance information is associated with each pixel of the image data. In each stereo camera 11 including two image sensors, images detected by each image sensor are combined and processed to create one distance image. Therefore, each stereo camera 11 is equivalent to one appearance sensor. The image data created by each image sensor and the distance image created by the image processing unit correspond to the appearance information because they are information indicating the appearance of the workplace.

The distance image is created in real time every time each image sensor creates the image data. Therefore, the distance image can be created with the same frequency as an imaging frequency. The image processing unit may be located in a separate housing that is physically separated from each stereo camera 11 having the image sensors.

Each stereo camera 11 is arranged so as to create the image data in front of the corresponding worker, that is, such that a lens faces in the same direction as the worker's eye level. In other words, each worker terminal 10 (stereo camera 11) is configured to fix to the corresponding worker so as not to change an orientation with respect to the corresponding worker. When each worker terminal 10 is fixed to the corresponding worker, an imaging direction of each stereo camera 11 matches a front direction of the corresponding worker. Accordingly, information in which each worker sees with his/her eyes can be acquired as the image data.

Each projector 12 can project an image inputted from the outside. Each projector 12 projects the image in front of the corresponding worker, with the same configuration as each stereo camera 11. Accordingly, each worker can see and recognize the image projected by each projector 12 regardless of the worker's orientation. A positional relationship (including the orientation) between each stereo camera 11 and each projector 12, which is obtained in advance, is stored in each worker terminal 10 or the controller 20. Therefore, for example, a position of each projector 12 in the workplace can be identified by identifying a position of each stereo camera 11 in the workplace.

Each communication device 13 includes a connector for wired communication with the corresponding stereo camera 11 and the corresponding projector 12 or a first antenna for wireless communication. Accordingly, each communication device 13 can exchange data with the corresponding stereo camera 11 and the corresponding projector 12. Each communication device 13 includes a second antenna for wireless communication with an external device (especially the controller 20). The second antenna may be different from the first antenna, or may be the same one as the first antenna. Each communication device 13 transmits the distance image inputted from the corresponding stereo camera 11 to the controller 20 via the second antenna, and receives the auxiliary image created by the controller 20 via the second antenna and then outputs the auxiliary image to the corresponding projector 12.

The controller 20 is configured as a computer equipped with a CPU, a ROM, a RAM, etc. The controller 20 creates the auxiliary image based on the distance image and other information received from each worker terminal 10 and transmits the created auxiliary image to each worker terminal 10. As shown in FIG. 1, the controller 20 includes a communication device (acquisition unit) 21, an analysis unit 22, a matching unit 23, an object information database 24, a registration unit 25, a work status information database 26, and a projection control unit 27. Each component in the controller 20 is conceptually divided for each process performed by the controller 20 (for each function of the controller 20). Although the controller 20 of this embodiment is realized by one computer, the controller 20 may be realized by a plurality of computers. In this case, these computers are connected to each other via network.

The communication device 21 includes a third antenna for wireless communication with external devices (especially each worker terminal 10). The communication device 21 is connected to each component in the controller 20 wirelessly or by wire. Accordingly, the communication device 21 can exchange data with each component in each worker terminal 10 and the controller 20. The communication device 21 acquires the distance image from each worker terminal 10 (acquisition step). The communication device 21 receives the distance image acquired from each worker terminal 10 via the third antenna and outputs the received distance image to the analysis unit 22. The communication device 21 also outputs the auxiliary image (specifically, data for which each projector 12 projects the auxiliary image) that is created by the projection control unit 27 to each worker terminal 10 via the third antenna.

The analysis unit 22 performs SLAM (Simultaneous Localization and Mapping) processing for the distance image inputted from the communication device 21. The analysis unit 22 creates a map information (environmental map) indicating shapes and positions of objects in the workplace by analyzing the distance image, and estimates a position and an orientation (a sensor position and a sensor orientation) of each stereo camera 11 (analysis step). The objects in the workplace are, for example, equipment, machines, tools, and workpieces (work objects) placed in the workplace.

In the following, a method for creating the map information will be specifically described. That is, the analysis unit 22 sets appropriate feature points by analyzing the distance image, and acquires its motion. The analysis unit 22, by using the known method, extracts and tracks a plurality of feature points from the distance image and thereby obtains data expressing in vector, the motion of the feature points on a plane corresponding to the image. Based on the obtained data, the analysis unit 22 generates the map information. The map information is data indicating the shapes and the positions of the objects in the workplace as described above. More specifically, the map information is data indicating a three-dimensional position of the extracted plurality of feature points (point groups). The analysis unit 22 estimates a change in the position and the orientation of each stereo camera 11 based on a change in a position and a distance of the inputted feature points and the position of the feature points in the map information. The map information created by the analysis unit 22, the position and the orientation of each stereo camera 11, and their changes are outputted to the matching unit 23.

The matching unit 23 performs a process of identifying the objects included in the map information. Specifically, three-dimensional model data of the objects in the workplace and identification information (name or ID) that identifies the objects are association with each other and stored in the object information database 24. As described above, the map information is the data indicating the three-dimensional position of the plurality of feature points. A part of an outline of the objects placed in the workplace is processed by the analysis unit 22 as one of the feature points in the map information. The matching unit 23 searches for one of the feature points corresponding to the three-dimensional model data of a predetermined object (for example, a tool A) stored in the object information database 24, among the plurality of feature points included in the map information obtained from the analysis unit 22, by using the known method. The matching unit 23 extracts one of the feature points corresponding to the predetermined object and identifies the position (for example, the position of a predetermined representative point) and the orientation of the predetermined object, based on the position of such corresponding feature point. The matching unit 23 creates data on a coordinate of the map information, the data added with the identification information of the identified object and its position and orientation. Such process is performed for various objects, which can obtain the data (an object coordinate data) indicating the positions and the orientations of various objects placed in the workplace, on the coordinate of the map information.

Weight, softness, degree of deformation of the objects, and work details using the objects are further registered in the object information database 24, as information regarding the objects. Such information and the identification information of the objects are referred to as an object information.

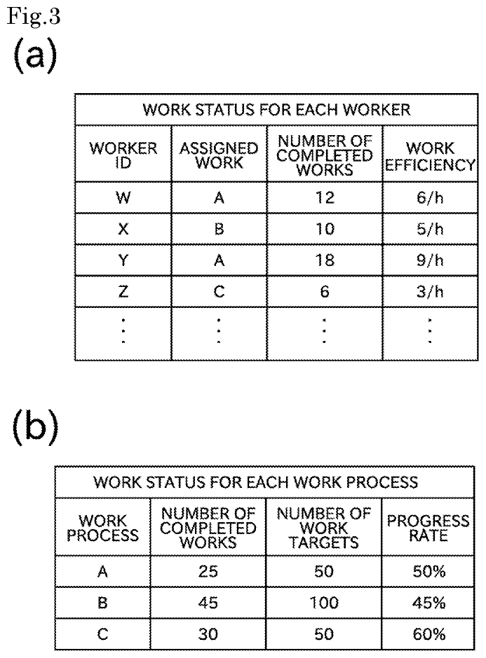

The registration unit 25 creates a work status information based on the information created by the analysis unit 22 and the matching unit 23, and registers the work status information in the work status information database 26 (registration step). The work status information is information regarding the work status in the workplace. The work status information includes, for example, the work details of the workers and a work progress status in the workplace. Specifically, changes in the position and the orientation of each stereo camera 11 correspond to changes in the position and the orientation of the corresponding worker (hereinafter, referred to as the changes in the worker's status). Each worker works, which leads to changes in the number, positions, orientations, or shapes of facility, equipment, tools, or workpieces (changes in a work environment). The information indicating a correspondence relation between the work details of the workers, and the change in the workers' status and the change in the work environment, is registered in the registration unit 25. The registration unit 25 compares the correspondence relation with the detected changes in the workers' status and the work environment, and thereby identifies what kind of work and how many times each worker has performed. Then, the registration unit 25 registers such identified result in the work status information database 26. As shown in FIG. 3 (a), the registration unit 25 calculates and registers assigned works, the number of completed works, and work efficiency (in which the number of completed works is divided by the unit time) for each worker. As shown in FIG. 3 (b), the registration unit 25 organizes data by focusing on the work process instead of the workers, and thereby can also calculate and register the number of completed works, the number of work targets, and a progress rate (in which the number of completed works is divided by the number of work targets) for each work process. The registration unit 25 may be configured to calculate the progress rate in the entire work, not for each work process. The image data created by each stereo camera 11 is also registered as the work status information in the work status information database 26. As such, the work status information is not pre-created information, but information containing the detected information. Therefore, the work status information changes in real time. Furthermore, the registration unit 25 outputs the information (the position and the orientation of each stereo camera 11, the object coordinate data) that is created by the analysis unit 22 and the matching unit 23, to the projection control unit 27.

In this embodiment, analyzing by the analysis unit 22 and matching by the matching unit 23 are performed for each received appearance information (in other words, for each worker terminal 10). Alternately, after integrating the sets of appearance information, analyzing by the analysis unit 22 and matching by the matching unit 23 may be performed.

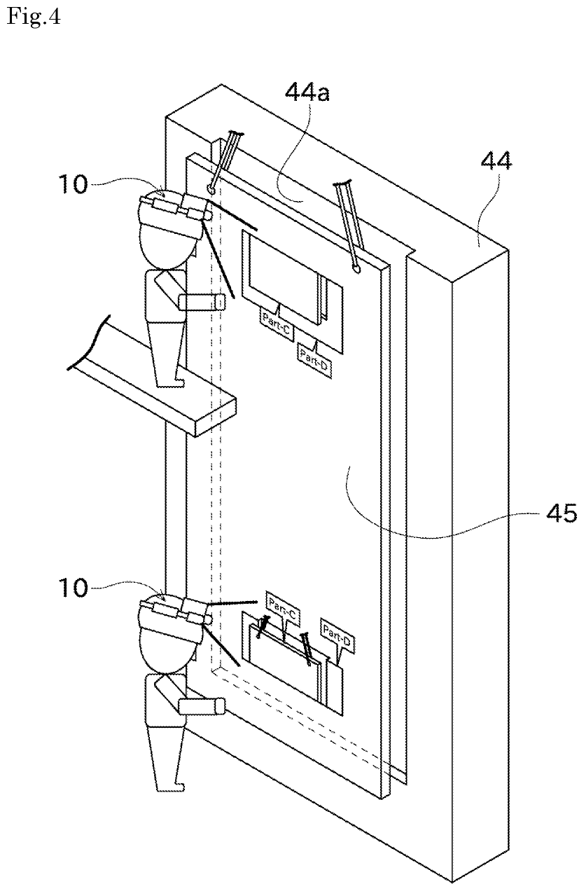

Based on the information registered in the object information database 24 and the work status information database 26 and based on the information inputted from the registration unit 25, the projection control unit 27 creates the auxiliary image and outputs it to the corresponding projector 12 such that the auxiliary image is projected to the workplace (projection control step). The information indicating the correspondence relation between the work details of the workers and details of the auxiliary image is registered in the projection control unit 27, in order to create the auxiliary image depending on the work status. The projection control unit 27 compares the correspondence relation with current work details of the workers obtained from the work status information database 26, and thereby identifies the details of the auxiliary image to be projected depending on the current work details of the workers. The details of the auxiliary image include, for example, the auxiliary image based on the object information and the auxiliary image based on the work status information. The projection control unit 27 creates the auxiliary image different for each worker (for each worker terminal 10) and projects the auxiliary image to the corresponding projector 12. In the following, the auxiliary image created by the projection control unit 27 will be specifically described with reference to FIG. 2 and FIG. 4.

FIG. 2 shows a situation in which the auxiliary image created based on the object information and the work status information is projected to the workplace. In the situation of FIG. 2, a tool 41, a first component 42, and a second component 43 are placed on a work table 40. In the situation of FIG. 2, each worker works to move the first component 42 onto the second component 43.

An upper area in FIG. 2 shows a situation before the auxiliary image is projected, and a lower area in FIG. 2 shows a situation after the auxiliary image is projected. In the lower area in FIG. 2, the auxiliary image including names of the objects (identification information) and the work details using the objects is projected. In the lower area in FIG. 2, the auxiliary image is shown by a broken line.

The projection control unit 27 can recognize the positions and the orientations of the objects and the position and the orientation of each stereo camera 11 in real time, based on the data received from the matching unit 23. Furthermore, the projection control unit 27 stores a positional relationship between each stereo camera 11 and each projector 12 in advance. Therefore, the projection control unit 27 can project the auxiliary image at a position considering the positions and the orientations of the objects. Specifically, when projecting characters such as the names of the objects, the characters are projected onto a flat portion near the objects so as to see and recognize the characters. When projecting the characters on a curved portion, the projection control unit 27 projects the characters which are distorted according to a shape of the curved portion to be projected, which can project the characters on the curved portion in a manner that the workers can see and recognize the characters. When projecting the work details, the projection control unit 27 projects the image indicating a moving destination and a moving direction of the first component 42 as the auxiliary image, in addition to the characters indicating the work details.

The auxiliary image is projected as above, which can easily share the auxiliary image among the plurality of workers. For example, skilled workers can teach beginners work procedures while pointing at the auxiliary image. The above-described teaching is difficult in a system configured to display virtual images on the HMD. Therefore, efficient teaching of the work procedures can be realized with the information projection system 1. The projection control unit 27 can acquire the position and the posture of each stereo camera 11 in real time. Therefore, if the position of each worker terminal 10 is displaced, the auxiliary image can be projected to a correct position without readjusting a wearing position. Unlike the system using the HMD, the workers can directly see and recognize the workplace without a transparent display. As described above, labor and burden of the workers can be reduced while improving the work efficiency.

FIG. 4 shows a situation in which the work status information registered in the work status information database 26 is projected as the auxiliary image. The work in which a fourth component 45 is mounted to a recess 44a formed in a third component 44 is performed in the situation shown in FIG. 4. Since the third component 44 and the fourth component 45 are very large components compared to the workers, two workers work to mount the fourth component 45 at an upper site and a lower site, respectively. In this situation, the two workers need to mount the fourth component 45 while checking each other's work status. However, such mounting work is difficult because the fourth component 45 is very large.

In this embodiment, the image data created by each stereo camera 11 is also registered as the work status information, and thus this image data is projected as the auxiliary image. Specifically, the image data created by each stereo camera 11 of a second worker on the lower site is projected as the auxiliary image from the corresponding projector 12 of a first worker on the upper site. As with FIG. 2, the names of the objects are projected as the auxiliary image at the same time. On the other hand, the names of the objects and the image data created by each stereo camera 11 of the first worker on the upper site are projected as the auxiliary image from the corresponding projector 12 of the second worker on the lower site. Accordingly, the workers can work while checking each other's work status. As such, in an example shown in FIG. 4, the auxiliary image that is information acquired in each worker terminal 10 of other workers, the auxiliary image in accordance with the work performed by the worker, is projected.

In the example shown in FIG. 4, the image data and the names of the objects are displayed.

However, instead of or in addition to the image data and the names of the objects, the positions of the objects calculated from the map information can be projected as the auxiliary image. Since the amount of positional displacement between the third component 44 and the fourth component 45 is quantified based on the map information, for example, the quantified amount of positional displacement can be projected as the auxiliary image. The situation shown in FIG. 4 is an example. For example, the workers facing each other across large components or walls larger than the workers can share each other's image data.

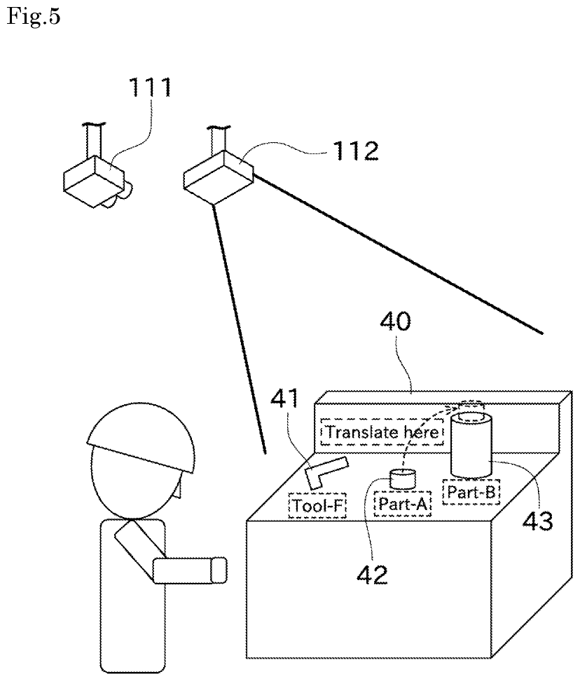

Next, variation of the above-described embodiment will be described with reference to FIG. 5. FIG. 5 is a diagram showing a variation in which a stereo camera 111 and a projector 112 are mounted in the workplace, not in each worker terminal 10.

In this variation, the stereo camera 111 and the projector 112 are mounted on, for example, walls or ceiling of the workplace. Even in such configuration, the map information can be generated based on the image data and the distance image created by the stereo camera 111. In the configuration of this variation, the information for each worker can be obtained by identifying each worker by matching of the matching unit 23.

Since the stereo camera 111 and the projector 112 are fixed, the positional relationship can stored in advance. The auxiliary image can be projected considering the positions and the orientations of the objects in the map information. Even if at least one of the stereo camera 111 and the projector 112 is configured to be changeable in its position and orientation, the positional relationship can be calculated according to details of a position control or a posture control. Therefore, the auxiliary image can be projected considering the positions and the orientations of the objects in the same way as above.

Instead of this variation, one of the stereo camera 111 and the projector 112 may be arranged in each worker terminal 10 and the other may be arranged in the workplace. In this case, if the position and the orientation of the projector 112 can be identified based on the created map information, the auxiliary image can be projected considering the positions and the orientations of the objects.

As described above, the information projection system 1 includes a plurality of stereo cameras 11, 111 for detecting an appearance of a workplace, a controller 20, and projectors 12, 112 for projecting images. The controller 20 has a communication device 21, an analysis unit 22, a registration unit 25, and a projection control unit 27. The communication device 21 acquires the sets of appearance information (a pair of image data or a distance image) obtained by detecting the appearance of the workplace by using the stereo cameras 11,111. The analysis unit 22 analyzes the sets of appearance information acquired by the communication device 21, and creates a map information indicating shapes and positions of objects existing in the workplace. The registration unit 25 creates and registers a work status information regarding a work status in the workplace, based on the map information that is individually created from the sets of appearance information respectively detected by the plurality of the stereo cameras 11,111. The projection control unit 27 creates an auxiliary image for assisting workers' work in the workplace, based on the work status information, outputs the auxiliary image to the projectors 12, 112, and then projects the auxiliary image to the workplace.

Accordingly, unlike a configuration in which the auxiliary image is displayed on an HMD, a projected image can be easily shared among the plurality of workers. The auxiliary image based on the work status information that is not predetermined information, but detected information, is projected to the workplace. Therefore, the workers can recognize various information regarding the objects existing in the workplace.

In the information projection system 1 of the above-described embodiment, the communication device 21 acquires the sets of appearance information detected by the stereo cameras 11 worn by the workers in the workplace.

Accordingly, the work status information including the position and the orientation of each worker can be created. The information in which each worker sees with his/her eyes can be included in the work status information. Furthermore, since the corresponding stereo camera 11 moves, the map information can be created based on the sets of appearance information obtained from various viewpoints.

In the information projection system 1 of the above-described embodiment, the projection control unit 27 projects the auxiliary image for assisting a work of each worker who wears the corresponding projector 12 one by one, from the corresponding projector 12 worn by each worker.

Accordingly, the information necessary for each worker can be projected from the corresponding projector 12.

In the information projection system 1 of the above-described embodiment, the projection control unit 27 controls to project the auxiliary image from the corresponding projector 12 worn by the second worker to the workplace, the auxiliary image that is created based on the appearance information detected by the corresponding stereo camera 11 worn by the first worker.

Accordingly, for example, the second worker can confirm information (especially, information regarding a current work status) in which the second worker cannot directly confirm, via each stereo camera 11 worn by the first worker.

In the information projection system 1 of the above-described embodiment, the registration unit 25 creates and registers at least one of the worker's work status and the work progress in the workplace, based on at least one of the number, positions, orientations, and shapes of the objects included in the work status information.

Accordingly, the work status is determined based on the information regarding the current work status, which can obtain an accurate work status in real time.

The information projection system 1 of the above-described embodiment includes the matching unit 23 configured to identify the objects included in the map information by matching the map information with the three-dimensional data of the objects. The projection control unit 27 controls to project the auxiliary image including object information identified by the matching unit 23, from the corresponding projector 12 to the workplace.

Accordingly, the auxiliary image of the identified object can be projected, which can improve work efficiency of the workers and can reduce the work mistake.

In the information projection system 1 of the above-described embodiment, the projection control unit 27 acquires the object information associated with the objects identified by the matching unit 23, and projects the auxiliary image including the object information from each projector 12, to a projection position determined based on the shapes and the positions of the objects included in the map information.

Accordingly, the auxiliary image can be projected to the projection position determined based on the shapes and the positions of the objects, which can project the auxiliary image in a position and a manner in which the workers can see and recognize. The object information associated with the objects is displayed, and thereby the workers' work can be assisted.

Although a preferred embodiment of the present invention and the variation have been described above, the above-described configuration can be modified, for example, as follows.

Monocular cameras may be used as the appearance sensors, instead of the stereo cameras 11. In this case, the analysis unit 22 and the matching unit 23 can identify the positions and the postures of the objects and recognize the objects by using the following method. Firstly, images of the objects that may be placed in the workplace, the images taken in various directions and at distances, are created. These images may be photographs, or CG images based on 3D model. These images, directions and distances in which these images were taken, and identification information of the objects shown by these images, etc. are read into a computer with machine learning. By using a model created by the above-described machine learning, the objects can be recognized based on the images of the objects and identify a relative position of an imaging position with respect to the objects. Such method is applicable not only to the monocular cameras but also to the stereo cameras 11. If the stereo cameras 11 are the monocular cameras, the analysis unit 22 may perform a known monocular Visual-SLAM process to detect the same information as this embodiment. Instead of the stereo cameras 11, a known configuration in which the monocular cameras and gyro sensors are combined may be used to acquire parallax information and use it for SLAM technology.

A three-dimensional LIDAR (Laser Imaging Detection and Ranging) capable of three-dimensionally measuring may be used as the appearance sensors, instead of the stereo cameras 11. In this case, as compared with a case of using the stereo cameras 11, three-dimensional positions of the objects can be measured more accurately. By using a laser, scanning can be performed while suppressing external influences such as brightness.

In the above-described embodiment, various information has been described as the work status information as an example, but only a part of various information may be created and registered. Information different from the above-described information may be created and registered. For example, when only image data is registered as the work status information, matching processing by the matching unit 23 is unnecessary.

### DESCRIPTION OF THE REFERENCE NUMERALS

1 information projection system

10 worker terminal

11, 111 stereo camera (appearance sensor)

12, 112 projector

13 communication device

20 controller

21 communication device (acquisition unit)

22 analysis unit

23 matching unit

24 object information database

25 registration unit

26 work status information database

27 projection control unit

1. An information projection system comprising:
a plurality of appearance sensors for detecting an appearance of a workplace;
a controller; and
a projector for projecting images, wherein
the controller includes:
an acquisition unit configured to acquire sets of appearance information obtained by detecting the appearance of the workplace using the plurality of appearance sensors;
an analysis unit configured to analyze the sets of appearance information acquired by the acquisition unit and then create a map information indicating shapes and positions of objects existing in the workplace;
a registration unit configured to create and register a work status information regarding a work status in the workplace, based on the map information that is individually created from the sets of appearance information respectively detected by the plurality of appearance sensors, or based on the map information created by integrating the sets of appearance information; and
a projection control unit configured to create an auxiliary image for assisting workers' work in the workplace based on the work status information, the projection control unit configured to output the auxiliary image to the projector and then project the auxiliary image to the workplace.

2. The information projection system according to claim 1, wherein
the acquisition unit acquires the sets of appearance information detected by the plurality of appearance sensors worn by workers in the workplace.

3. The information projection system according to claim 2, wherein
the projection control unit controls to project the auxiliary image for assisting a work of each worker who wears the projector, from the projector worn by each worker.

4. The information projection system according to claim 3, wherein
the projection control unit controls to project the auxiliary image from the projector worn by a second worker to the workplace, the auxiliary image that is created based on the appearance information detected by the corresponding appearance sensor worn by a first worker.

5. The information projection system according to claim 1, wherein
the registration unit creates and register at least one of a work status of each worker and a work progress in the workplace, based on at least one of the number, positions, orientations, and shapes of objects included in the work status information.

6. The information projection system according to claim 1 wherein
a matching unit configured to identify the objects included in the map information by matching the map information with three-dimensional data of the objects, is provided, wherein,
the projection control unit controls to project the auxiliary image including object information associated with the objects identified by the matching unit, from the projector to the workplace.

7. The information projection system according to claim 6, wherein
the projection control unit controls to acquire the object information associated with the objects identified by the matching unit, and project the auxiliary image including the object information from the projector, to a projection position determined based on the shapes and the positions of the objects included in the map information.

8. A controller configured to acquire sets of appearance information detected by a plurality of appearance sensors for detecting an appearance of a workplace, the controller configured to output images to a projector, the images for which the projector projects, the controller comprising:
an analysis unit configured to analyze the sets of appearance information and then create a map information indicating shapes and positions of objects existing in the workplace;
a registration unit configured to create and register a work status information regarding a work status in the workplace, based on the map information that is individually created from the sets of appearance information respectively detected by the plurality of appearance sensors, or based on the map information created by integrating the sets of appearance information; and
a projection control unit configured to create an auxiliary image for assisting workers' work in the workplace based on the work status information, the projection control unit configured to output the auxiliary image to the projector and then project the auxiliary image to the workplace.

9. An information projection method comprising:
an acquisition step of acquiring sets of appearance information obtained by detecting an appearance of a workplace using a plurality of appearance sensors;
an analysis step of analyzing the sets of appearance information acquired in the acquisition step, and creating a map information indicating shapes and positions of objects in the workplace;
a registration step of creating and registering a work status information regarding a work status in the workplace, based on the map information that is individually created from the sets of appearance information respectively detected by the plurality of appearance sensors, or based on the map information created by integrating the sets of appearance information; and
a projection control step of creating an auxiliary image for assisting workers' work in the workplace based on the work status information, the projection control step of outputting the auxiliary image to a projector and then projecting the auxiliary image to the workplace.
